(19) United States
(12) Patent Application Publication
(10) Pub. No.: US 2015/0050632 A1
(43) Pub. Date: Feb. 19, 2015

(54) ACTIVE LEARNING SYSTEMS AND METHODS

(71) Applicant: Deep SRAN, Ashburn, VA (US)

(72) Inventor: Deep Sran, Ashburn, VA (US)

(21) Appl. No.: 14/390,385

(22) PCT Filed: Mar. 15, 2013
(86) PCT No.: PCT/US2013/032695

§ 371 Date: Oct. 2, 2014

Related U.S. Application Data
(60) Provisional application No. 61/619,918, filed on Apr. 3, 2012.
(60) Provisional application No. 61/620,407, filed on Apr. 4, 2012.

(51) Int. Cl. G09B 5/02; G09B 7/00; G09B 5/04

(52) U.S. Cl. CPC G09B 5/02; G09B 5/04; G09B 7/00
USPC 434/319; 434/362; 434/322

(57) ABSTRACT

Methods, systems and computer readable media for active learning are described. Some implementations can include an augmented media active learning system comprising one or more processors coupled to a database, wherein the one or more processors are configured to perform operations. The operations can include receiving a media content item, and receiving one or more gate groups from a system associated with an instructor, wherein each gate groups includes a location at which the gate should appear in the media content item, gate content and one or more gate response attributes. The operations can also include combining the one or more gate groups and the media content item to generate an augmented media content item, and storing the augmented media content item in the database.

### RELATED APPLICATIONS

This application claims the benefit of U.S. Provisional Application No. 61/619,918, entitled “Layered Media System and Method” and filed on Apr. 3, 2012; and U.S. Provisional Application No. 61/620,407, entitled “Layered Media System and Method” and filed on Apr. 4, 2012, both of which are incorporated herein by reference in their entirety.

### TECHNICAL FIELD

Embodiments relate generally to computerized education delivery systems and methods, and more particularly, to methods, systems and computer readable media for active learning.

### BACKGROUND

Some electronic media devices can be used for educational purposes. However, these devices may provide a passive educational experience. A reader's consumption of conventional electronic media on a media player (e.g., reading an ebook, listening to an audio program or viewing a video) may not be observable or measurable by an instructor. Also, and perhaps more importantly, the reader's learning progress may not be measurable in real-time (e.g., as the reader consumes the media) with conventional media players and electronic media.

Some implementations were conceived in light of the above-mentioned problems and limitations, among other things.

### SUMMARY

Some implementations can include an augmented media active learning system comprising one or more processors coupled to one or more databases containing media augmentation information (e.g., gates), reader responses, wherein the one or more processors are configured to perform operations. The operations can include receiving a media content item, and receiving one or more gate groups from a system associated with an instructor, wherein each gate groups includes a location at which the gate should appear in the media content item, gate content and one or more gate response attributes. The operations can also include combining the one or more gate groups and the media content item to generate an augmented media content item, and storing the augmented media content item in the database.

The operations can further include causing the augmented media content item to be displayed on one or more user devices, and receiving a response from a user device. The operations can also include storing the response in the database.

The media content item can include an electronic text, an article, a book, a video, or an audio program, a portion of any of the above, or a combination of any of the above. In general, any text can be used. The operations can further include preventing a user from advancing past a gate in the augmented media content item until the user has completed a corresponding gate response. Each gate group can include at least one required action. The at least one required action can includes one or more of answering a question, making a connection to previous material, adding to a reader outline and posting content to a reader discussion forum.

The operations can further include receiving help content for one or more corresponding gate groups to be displayed when an indication is received from a reader that help is needed with a corresponding gate group. The gate content can include one or more of text, video and audio.

The user devices can include one or more of a tablet device, a smart phone, an electronic book reader and an electronic media player. The operations can further include preventing a user from advancing past a gate in the augmented media content item until the user has completed a corresponding gate response.

The operations can further include providing help content corresponding to one or more gate groups.

Some implementations can include a method including receiving, at one or more processors, a media content item, and receiving, at the one or more processors, a gate location indication specifying a location in the media content item. The method can also include receiving, at the one or more processors, gate content information corresponding to the gate location indication, and receiving, at the one or more processors, one or more gate response parameters associated with the gate content information.

The method can further include combining, using the one or more processors, the media content item and the gate location, gate content information and gate response parameters into an augmented media content item, and providing the augmented media content item for display to one or more reader devices.

The method can further include receiving a response to the gate content. The method can also include updating the augmented media content item with the response. The media content item can include an electronic book, a video, an article or an audio program.

The operations can further include preventing a user from advancing past a gate in the augmented media content item until the user has completed a corresponding gate response.

The one or more gate response parameters can include at least one required action. The at least one required action includes one or more of answering a question, making a connection to previous material, adding to a reader outline and posting content to a reader discussion forum.

The operations can further include receiving help content for one or more corresponding gates to be displayed when an indication is received from a reader that help is needed with a corresponding gate. The gate content can include one or more of text, video and audio.

The user devices can include one or more of a tablet device, a smart phone, an electronic book reader and an electronic media player.

Some implementations can include a system for active learning having one or more processors configured to perform a method according to any of the steps mentioned above.

Some implementations can include a nontransitory computer readable medium having stored thereon software instructions that, when executed by a processor, cause the processor to perform a method according to any of the steps mentioned above.

Some implementations can include a method including receiving an augmented media content item at a reader device, and displaying the augmented media content item. The method can also include receiving an indication that the reader has reached a gate location, and preventing the media content item from being advanced past the gate location. In some implementations, content past the gate may be visible or may be visible and grayed out or otherwise presented as content beyond a gate that has not been responded to. The method can further include displaying gate content, and processing one or more gate response parameters that define a response type for a gate.

The method can also include receiving a response to the gate, and transmitting the response to an active learning system. The method can further include unlocking the media content item in order to permit a user to advance past the gate location.

The method can also include updating the augmented media content item with the response. The augmented media content item can include an electronic book, a video, an article or an audio program.

The one or more gate response parameters can include at least one required action. The at least one required action can include one or more of answering a question (e.g., writing an open-form written composition answer, providing an answer to a multiple choice question and/or providing an answer to a short answer question), making a connection to previous material, adding to a reader outline (e.g., writing a new outline entry) and posting content to a reader discussion forum. The method can also include receiving help content for one or more corresponding gates to be displayed when an indication is received from a reader that help is needed with a corresponding gate.

The gate content can include one or more of text, video and audio. The user devices can include one or more of a tablet device, a smart phone, an electronic book reader, a wearable computer, a television, and an electronic media player.

Some implementations can include a system for active learning having one or more processors configured to perform a method according to any of the steps described above.

Some implementations can include a nontransitory computer readable medium having stored thereon software instructions that, when executed by a processor, cause the processor to perform a method according to any of the steps described above.

Some implementations can include a method comprising receiving, at one or more processors, one or more gate responses, and automatically evaluating the one or more gate responses by comparing the one or more responses to one or more model responses. The method can also include receiving instructor evaluation on the one or more gate responses, and updating reader progress and performance information based on one or more of the gate responses, automatic evaluation and instructor evaluation. The method can further include providing feedback to users associated with the one or more gate responses.

Some implementations can include a system for active learning having one or more processors configured to perform a method according to the steps described above.

Some implementations can include a nontransitory computer readable medium having stored thereon software instructions that, when executed by a processor, cause the processor to perform a method according to the steps described above.

Implementations described herein provide various advantages. For example, implementations encourage readers to actively learn, because the system facilitates instructor questions and corresponding reader responses on educational content.

### BRIEF DESCRIPTION OF THE DRAWINGS

FIG. 1 is a diagram of an example active learning system in accordance with at least one embodiment.

FIG. 2 is a diagram of an example active learning system reader network in accordance with at least one embodiment.

FIG. 3 is a diagram of an example computer system in accordance with at least one embodiment.

FIG. 4 is a flow chart of an example method for active learning with augmented media in accordance with at least one embodiment.

FIG. 5 is a flow chart of an example method for processing an augmented media content item in accordance with at least one embodiment.

FIG. 6 is a flow chart of an example method for assessment of reader progress with an augmented media content item in accordance with at least one embodiment.

FIG. 7 is a diagram of an example active learning graphical user interface in accordance with some implementations.

### DETAILED DESCRIPTION

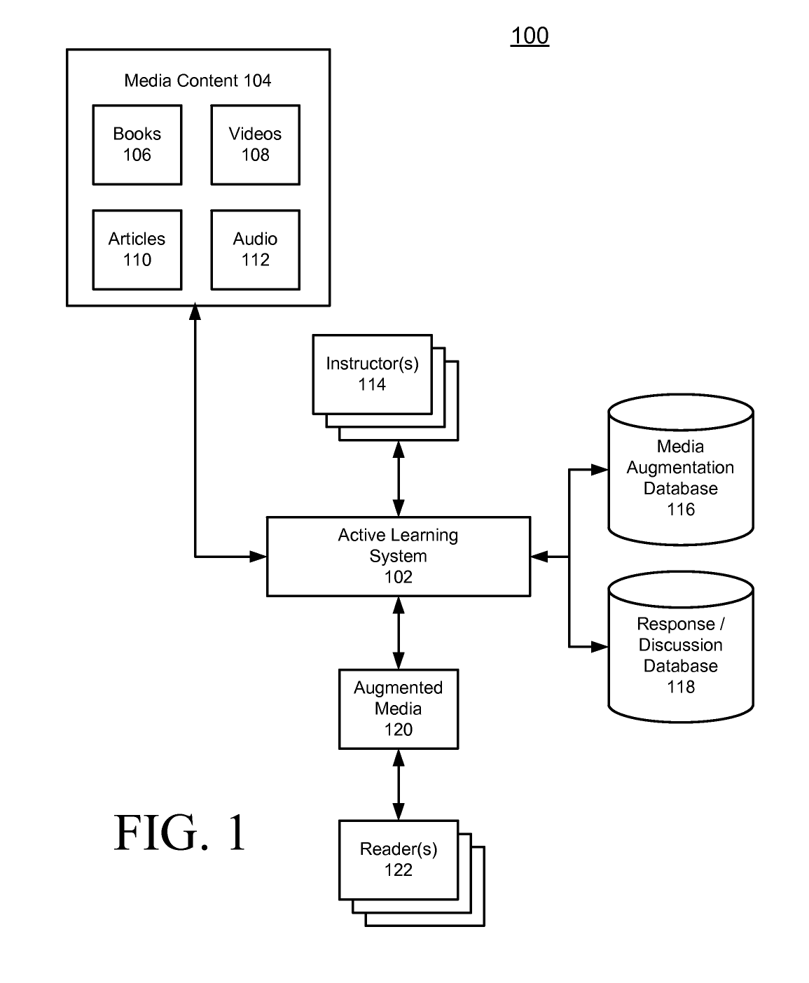

FIG. 1 is a diagram of an example active learning environment 100. The environment includes an active learning system 102 coupled to a source of media content 104, including but not limited to electronic text, text, blog posts, link, books 106, videos 108, articles 110 and audio programs 112. The system 102 is also coupled to one or more instructors 114, and one or more databases. In an example implementation, the environment includes a media augmentation database 116, and a response/discussion database 118.

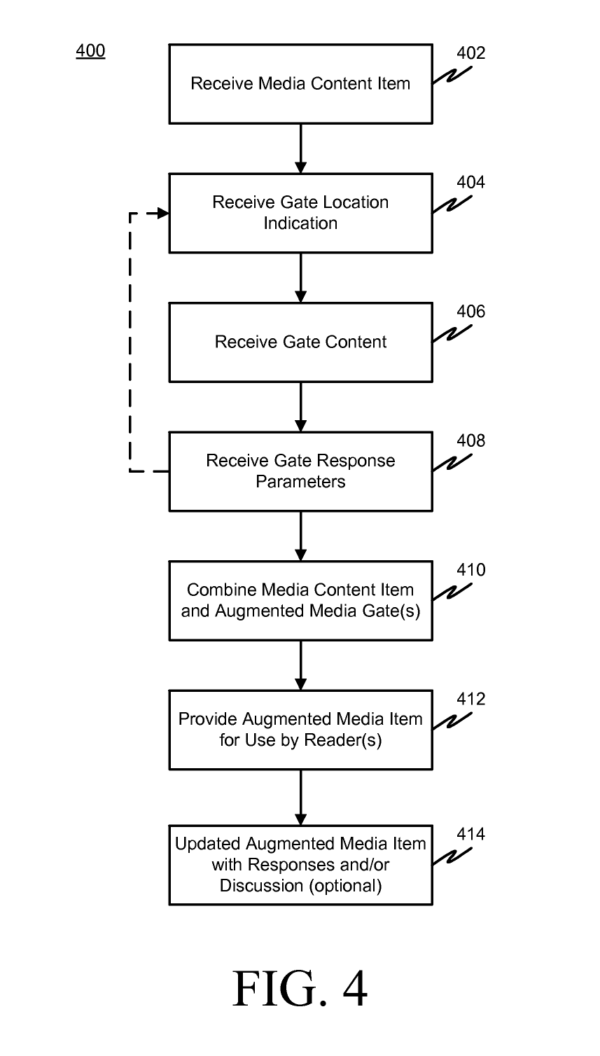

In operation, the system 102 receives one or more media content items 104 (e.g., 106-112) and also receives information for one or more gates 114. In some implementations, the gates can be received from one or more of an automatic system, an instructor, a gate author, a pre-packaged gate layer for a media item or the like. The system 102 combines the media content item 104 with the one or more gates to produce an augmented media content item 120 for presentation to one or more readers 122. Details of the operation of the system 102 are described below in connection with FIGS. 4-6.

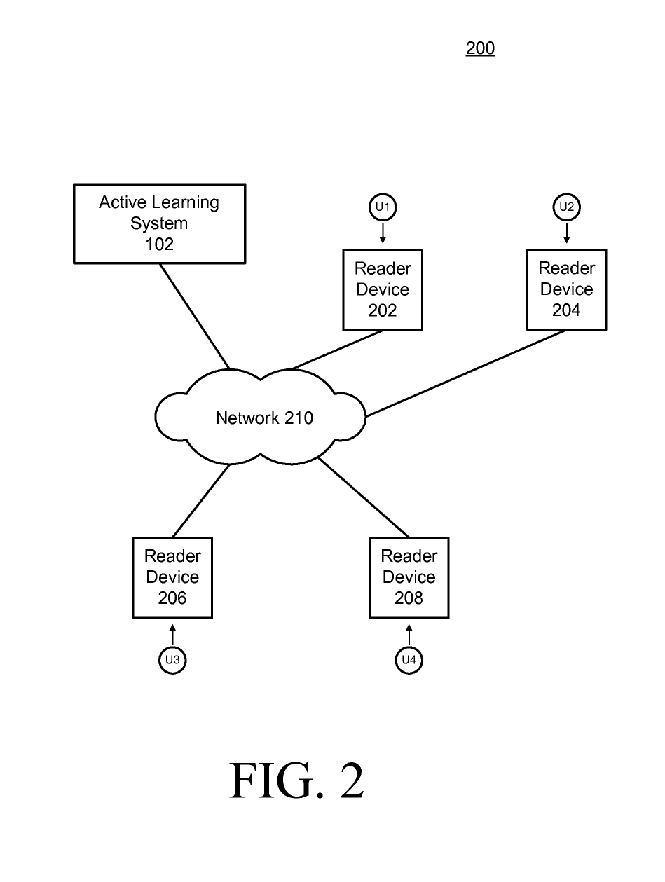

FIG. 2 shows a plurality of reader devices (202-208) coupled to an active learning system 102 via a network 210. Examples of reader devices (202-208) may include but not be limited to personal computers, laptops, tablets, mobile internet devices, smart phones, wearable computers, and the like. In operation, readers (e.g., U1-U4) can interact with each other and their instructors via the active learning system 102, as described below. The network 210 can be wired, wireless or a combination of the two.

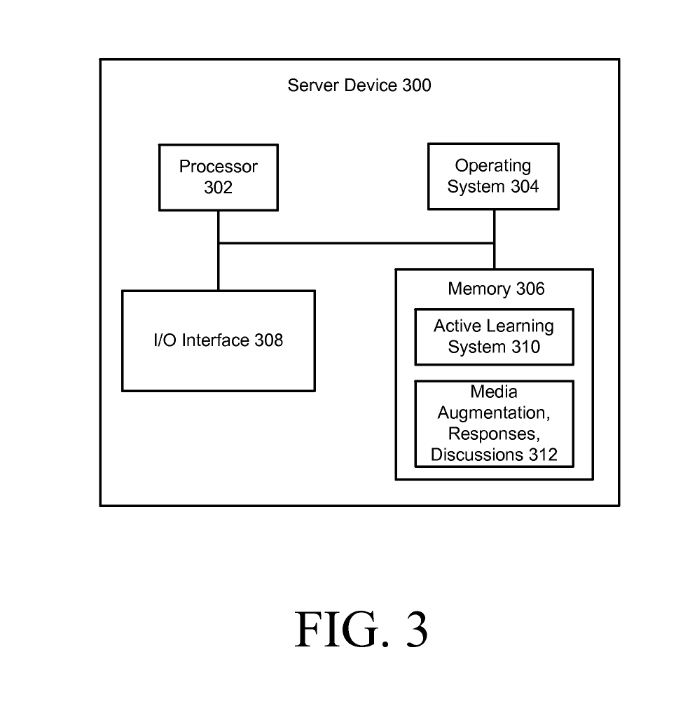

FIG. 3 is an example computer server system 300 for electronic publishing in accordance with at least one embodiment. The server device 300 includes a processor 302, operating system 304, memory 306 and I/O interface 308. The memory 306 can include an active learning application 310 and one or more media augmentations, gates, responses, discussions or the like 312.

In operation, the processor 302 may execute the application 312 stored in the memory 306. The application 312 can include software instructions that, when executed by the processor, cause the processor to perform operations for active learning in accordance with the present disclosure (e.g., performing one or more of steps 402-414, 502-514 and 602-610 described below).

The application program 312 can operate in conjunction with the stored media content, such as electronic text, text, blog posts, link, books, videos, audio, manuscripts, articles and reviews 312 and the operating system 304.

FIG. 4 is a flow chart of an example method 400 for active learning with augmented media in accordance with at least one embodiment. Processing begins at 402, where a media content item is received. The media content item can include but not be limited to one or more of a book, text, electronic text, text, blog post, an image, a link, a video, an article and an audio program. Processing continues to 404.

At 404, a gate location indication is received. For example, an instructor can use an augmented media content authoring tool to move to a point in the media content item where the instructor would like to insert a gate. A gate is a stopping point in the media item at which a reader must take a specific action before proceeding in the media content item. In addition to requiring a reader to take an action, the gate can also be used to present content. In an example implementation, the gate location is a prompt that the system 102 displays to the reader. Processing continues to 406.

At 406, gate content is received. The content can include one or more of text (e.g., a question from the instructor), video and audio file. In some implementations, gate questions can be retrieved from an external database of questions about a work. In an example implementation system 102 provides a user interface that includes gate content. In some implementations user interface may enable the reader to enter text, select answers using buttons, record an audio response, or provide a video response. In another example implementation, the user interface can be configured to permit a reader to submit a written composition as a response to a gate. Processing continues to 408.

At 408, gate response parameters are received. The response parameters can include how a reader is to respond and can also include criteria for automatically evaluating reader responses. Responses parameters can include answer format (e.g., free form text, multiple choice, true/false or the like) and possibly model answer content or parameters for determining an answer is likely acceptable (e.g., length of text response, presence of key words or the like). In some example implementations customized gate location, gate content, and corresponding gate response parameters are pre-prepared and provided for an entire particular electronic text or work, and can be retrieved or purchased from a database. Processing continues to 410.

At 410, the media content item is combined with the gates (e.g., gate location, gate content and response parameters) to create an augmented media content item. Processing continues to 412.

At 412, the augmented media content item (e.g., text with gates, video with gates, audio with gates or the like) is provided for use by readers. Processing continues to 414.

At 414, the augmented media content item can optionally be updated with responses and or class discussion content. It will be appreciated that 402-414 can be repeated in whole or in part in order to accomplish a contemplated active learning task. For example, 404-408 can be repeated for each gate added to a media content item.

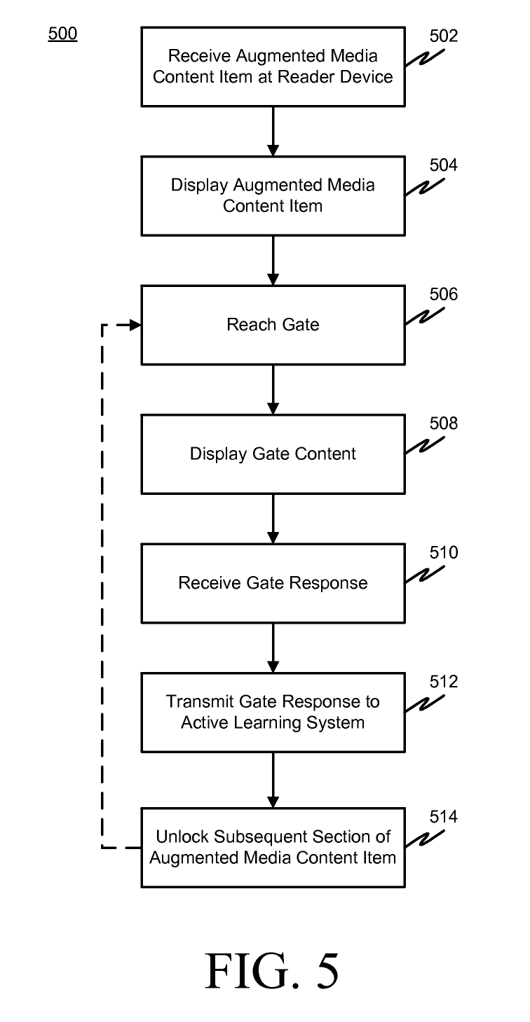

FIG. 5 is a flow chart of an example method 500 for processing an augmented media content item in accordance with at least one embodiment. Processing begins at 502, where an augmented media content item is received at a reader device. Processing continues to 504.

At 504, the reader device causes the augmented media content item to be displayed. Processing continues to 506.

At 506, a signal is received that indicates the reader has reached a gate. The gates on a page become active when a reader reaches that page. Processing continues to 508.

At 508, the gate content is displayed. Processing continues to 510.

At 510, a response to the gate is received at the reader device (e.g., the reader answered a question, made a connection with other material, prepared a written composition, made a note in an outline or the like). Processing continues to 512.

At 512, the response to the gate is transmitted to the active learning system. The system can track reader responses to various questions in order to improve the learning process. For example, the system could include an adaptive component configured to generate new gates based on reader responses. Thus the system could adapt to the responses of readers by automatically including new gates without user input in order to further improve an augmented media item. Processing continues to 514.

At 514, the next section of the media content item is unlocked, without further reader input, for reading, listening and/or viewing. Also, once a user or reader submits a response to a gate, the other responses already received for that gate can be displayed. In some implementations the next section of media content may not be unlocked depending upon system 102 or instructor's evaluation of responses. In some implementations, system 102 may request further action from the reader, such as a supplemental response, before system 102 unlocks and provides the next section of media content. In some implementations, the next section of media content may not be unlocked and may not be visible. In some implementations, the next section of media content may not be unlocked, however, may be partially visible (e.g. grayed out, highlighted, displayed in a different color font, etc.). It will be appreciated that 502-514 can be repeated in whole or in part in order to accomplish a contemplated active learning task. For example, 506-514 can be repeated as the reader(s) reach new gates.

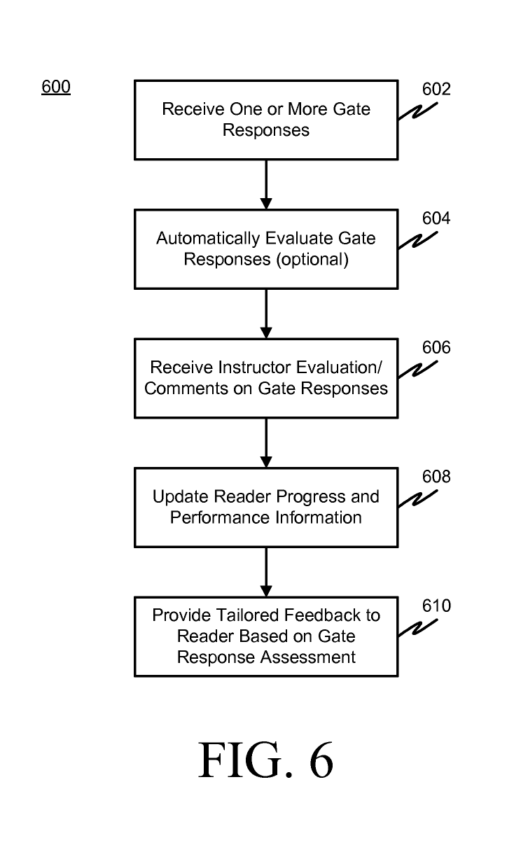

FIG. 6 is a flow chart of an example method 600 for assessment of reader progress with an augmented media content item in accordance with at least one embodiment. Processing begins at 602, where one or more responses to a gate are received. Processing continues to 604.

At 604, the gate responses are optionally automatically evaluated. This can include the system performing a semantic analysis of freeform typing answers. Also, a reader's response could be automatically compared to the reader's prior responses, other reader' responses, or information in the text or from an external source, such as a site on the Web. In some implementations, responses may be evaluated based on various types of predetermined criteria provided by the instructor or system 102. Processing continues to 606.

At 606, an evaluation and/or comments from an instructor can be received by the system. Processing continues to 608.

At 608, reader performance and progress charts or graphics can be updated based on the instructor evaluation and/or comments. Processing continues to 610.

At 610, tailored feedback can be optionally provided to a reader based an assessment of his/her gate responses.

It will be appreciated that 602-610 can be repeated in whole or in part in order to accomplish a contemplated active learning task.

In addition to the features mentioned above, the active learning system can put user devices (e.g., tablets or any of non-limiting example devices 202-208 described above), under screen control of a teacher so that the teacher essentially takes control, with the reader's consent, of the readers' tablet devices.

In some implementations, an algorithm to find the meaning of a text can be used to develop gates, without instructor or user input. In other implementations, an algorithm to find the meaning of a text can be used to develop gates, without user input, to help automate the media content augmentation process. The system can also track which questions get the best responses and then try to optimize the location in a media content item to place the gates.

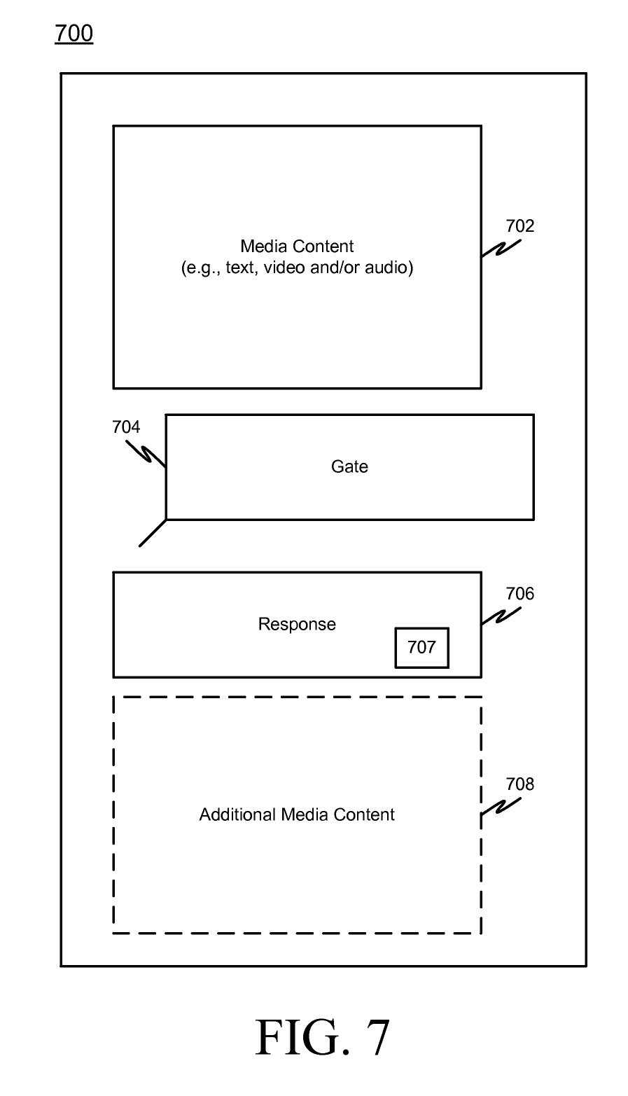

FIG. 7 is a diagram of an example active learning graphical user interface 700 in accordance with some implementations. The user interface includes a media content item 702, selected by an instructor for a reader. The user interface includes gate content 704 provided by instructor for reader. In the illustrated implementation, a response 706 may be sent to the instructor by the reader using a button 707. Additional media content 708 may be provided by system 102 after a response 706 by reader.

In an example scenario, the media content item 702 is text from the novel, “The Adventures of Huckleberry Finn” by Mark Twain. For example text may include “was Aunt Polly, or the widow, or maybe Mary. Aunt Polly—Tom's Aunt Polly, she—and Mary, and the Widow Douglas is all told about in that book, which is mostly a true book, with some stretchers, as I said before.” In an example scenario reader reads text on a tablet device, when they reach the end of the sentence (“. . . as I said before.”) system, without further user input causes to be displayed gate content 704.

In an example scenario, gate content 704 is the following question from the instructor to the reader, “ Why do you think the book begins with a reference to Twain's previous novel (The Adventures of Tom Sawyer) and to Twain himself as a “mainly truthful” author? How does this affect your initial impression of the novel, and of Huck Finn as a narrator?”

The reader may then send a response 706 to the instructor. In an example scenario, the reader's response may be “I think Twain wants to make sure the reader knows the novels are tied together in the reader's mind. Based on this paragraph, it appears Huck Finn will likely differ from Tom Sawyer and have a different perspective than him.” The reader may then send the response to the instructor by for example hovering over or clicking the button 707.

In an example scenario, system 102 may determine a response has been received from the reader. System 102 may than evaluate, without further user input or with instructor input, reader's response.

In an example scenario, after receiving and/or evaluating response 706 system 102 may then provide reader access to additional media content 708. For example media content, may be the next section of text of the novel, “The Adventures of Huckleberry Finn.”

Implementations described herein provide various advantages. For example, implementations encourage readers to actively learn, because the system facilitates instructor questions and corresponding reader responses on educational content.

It will be appreciated that the modules, processes, systems, and sections described above can be implemented in hardware, hardware programmed by software, software instructions stored on a nontransitory computer readable medium or a combination of the above. A system as described above, for example, can include a processor configured to execute a sequence of programmed instructions stored on a nontransitory computer readable medium. For example, the processor can include, but not be limited to, a personal computer or workstation or other such computing system that includes a processor, microprocessor, microcontroller device, or is comprised of control logic including integrated circuits such as, for example, an Application Specific Integrated Circuit (ASIC). The instructions can be compiled from source code instructions provided in accordance with a programming language such as Java, C, C++, C#.net, assembly or the like. The instructions can also comprise code and data objects provided in accordance with, for example, the Visual Basic™ language, or another structured or object-oriented programming language. The sequence of programmed instructions, or programmable logic device configuration software, and data associated therewith can be stored in a nontransitory computer-readable medium such as a computer memory or storage device which may be any suitable memory apparatus, such as, but not limited to ROM, PROM, EEPROM, RAM, flash memory, disk drive and the like.

Furthermore, the modules, processes systems, and sections can be implemented as a single processor or as a distributed processor. Further, it should be appreciated that the steps mentioned above may be performed on a single or distributed processor (single and/or multi-core, or cloud computing system). Also, the processes, system components, modules, and sub-modules described in the various figures of and for embodiments above may be distributed across multiple computers or systems or may be co-located in a single processor or system. Example structural embodiment alternatives suitable for implementing the modules, sections, systems, means, or processes described herein are provided below.

The modules, processors or systems described above can be implemented as a programmed general purpose computer, an electronic device programmed with microcode, a hard-wired analog logic circuit, software stored on a computer-readable medium or signal, an optical computing device, a networked system of electronic and/or optical devices, a special purpose computing device, an integrated circuit device, a semiconductor chip, and/or a software module or object stored on a computer-readable medium or signal, for example.

Embodiments of the method and system (or their sub-components or modules), may be implemented on a general-purpose computer, a special-purpose computer, a programmed microprocessor or microcontroller and peripheral integrated circuit element, an ASIC or other integrated circuit, a digital signal processor, a hardwired electronic or logic circuit such as a discrete element circuit, a programmed logic circuit such as a PLD, PLA, FPGA, PAL, or the like. In general, any processor capable of implementing the functions or steps described herein can be used to implement embodiments of the method, system, or a computer program product (software program stored on a nontransitory computer readable medium).

Furthermore, embodiments of the disclosed method, system, and computer program product (or software instructions stored on a nontransitory computer readable medium) may be readily implemented, fully or partially, in software using, for example, object or object-oriented software development environments that provide portable source code that can be used on a variety of computer platforms. Alternatively, embodiments of the disclosed method, system, and computer program product can be implemented partially or fully in hardware using, for example, standard logic circuits or a VLSI design. Other hardware or software can be used to implement embodiments depending on the speed and/or efficiency requirements of the systems, the particular function, and/or particular software or hardware system, microprocessor, or microcomputer being utilized. Embodiments of the method, system, and computer program product can be implemented in hardware and/or software using any known or later developed systems or structures, devices and/or software by those of ordinary skill in the applicable art from the function description provided herein and with a general basic knowledge of the software engineering and educational delivery system arts.

Moreover, embodiments of the disclosed method, system, and computer readable media (or computer program product) can be implemented in software executed on a programmed general purpose computer, a special purpose computer, a microprocessor, or the like.

It is, therefore, apparent that there is provided, in accordance with the various embodiments disclosed herein, methods, systems and computer readable media for active learning with augmented media content items.

While the disclosed subject matter has been described in conjunction with a number of embodiments, it is evident that many alternatives, modifications and variations would be, or are, apparent to those of ordinary skill in the applicable arts. Accordingly, Applicant intends to embrace all such alternatives, modifications, equivalents and variations that are within the spirit and scope of the disclosed subject matter.

1. An augmented media active learning system comprising:
one or more processors coupled to a database, wherein the one or more processors are configured to perform operations including:
receiving a media content item;
receiving one or more gate groups, wherein each gate groups includes a location at which the gate should appear in the media content item, gate content and one or more gate response attributes;
combining the one or more gate groups and the media content item to generate an augmented media content item;
storing the augmented media content item in the database;
causing the augmented media content item to be displayed on one or more user devices;
receiving a response from a user device; and
storing the response in the database.

2. The system of claim 1, wherein the media content item is text.

3. The system of claim 1, wherein the media content item is video.

4. The system of claim 1, wherein the media content item is an article.

5. The system of claim 1, wherein the media content item is an audio program.

6. The system of claim 1, wherein the operations further include preventing a user from advancing past a gate in the augmented media content item until the user has completed a corresponding gate response.

7. The system of claim 1, wherein each gate group includes at least one required action.

8. The system of claim 7, wherein the at least one required action includes one or more of answering a question, making a connection to previous material, adding to a reader outline and posting content to a reader discussion forum.

9. The system of claim 1, wherein the operations further include receiving help content for one or more corresponding gate groups to be displayed when an indication is received from a reader that help is needed with a corresponding gate group.

10. The system of claim 1, wherein the gate content can include one or more of text, video and audio.

11. The system of claim 1, wherein the user devices include one or more of a tablet device, a smart phone, an electronic book reader, a mobile internet device, wearable computer, and an electronic media player.

12. The system of claim 1, wherein the operations further include preventing a user from advancing past a gate in the augmented media content item until the user has completed a corresponding gate response.

13. The system of claim 1, wherein the operations further include providing help content corresponding to one or more gate groups.

14. A method comprising:
receiving, at one or more processors, a media content item;
receiving, at the one or more processors, a gate location indication specifying a location in the media content item;
receiving, at the one or more processors, gate content information corresponding to the gate location indication;
receiving, at the one or more processors, one or more gate response parameters associated with the gate content information;
combining, using the one or more processors, the media content item and the gate location, gate content information and gate response parameters into an augmented media content item; and
providing the augmented media content item for display to one or more reader devices.

15. The method of claim 14, further comprising receiving a response to the gate content.

16. The method of claim 15, further comprising updating the augmented media content item with the response.

17-20. (canceled)

21. The method of claim 14, wherein the operations further include preventing a user from advancing past a gate in the augmented media content item until the user has completed a corresponding gate response.

22. The method of claim 14, wherein one or more gate response parameters include at least one required action.

23. The method of claim 22, wherein the at least one required action includes one or more of answering a question, making a connection to previous material, adding to a reader outline and posting content to a reader discussion forum.

24-28. (canceled)

29. A method comprising:
receiving an augmented media content item at a reader device;
displaying the augmented media content item;
receiving an indication that the reader has reached a gate location;
preventing the media content item from being advanced past the gate location;
displaying gate content;
processing one or more gate response parameters that define a response type for a gate;
receiving a response to the gate;
transmitting the response to an active learning system; and p1 unlocking the media content item in order to permit a user to advance past the gate location.

30-44. (canceled)
